(19) United States
(12) Patent Application Publication
(10) Pub. No.: US 2017/0081123 A1
(43) Pub. Date: Mar. 23, 2017

(54) PERSONAL WATERCRAFT LIFTING APPARATUS AND METHOD

(71) Applicant: William Greener, Ithaca, NY (US)

(72) Inventor: William Greener, Ithaca, NY (US)

(21) Appl. No.: 15/254,352

(22) Filed: Sep. 1, 2016

Related U.S. Application Data
(60) Provisional application No. 62/221,775, filed on Sep. 22, 2015.

(51) Int. Cl. B65G 7/12; B63B 35/85

(52) U.S. Cl. CPC B65G 7/12; B63B 35/85; B63B 2035/715

(57) ABSTRACT

A personal watercraft (PW) lifting apparatus includes an elongate member having an adjustable, fixable length and having opposing distal ends and a gripping part, and a shaped end member fixedly or removable disposed on each respective distal end, each shaped end member having a shape adapted to engage a perimetal edge region or an external side region of the personal watercraft. A user can attach the appropriately shaped ends to appropriate regions of the PW; once secured, the user can then grasp two apparatus or two opposing holding regions of a single apparatus with both hands respectively, without having to turn or twist his/her wrists, enabling easier and more controlled lifting of the PW.

### RELATED APPLICATION DATA

The instant application claims priority to U.S. provisional application 62/221,775 filed Sep. 22, 2015, the subject matter of which is incorporated by reference in its entirety.

### BACKGROUND

Aspects and embodiments of the invention most generally pertain to apparatus and methods to assist in more easily and controllably lifting and maneuvering a personal watercraft; more particularly to one or a pair of adjustable handle apparatus that are removeably attachable to a personal watercraft in a transverse orientation and which enable grasping by a user's hands substantially without twisting the user's wrists to facilitate lifting of the personal watercraft.

Personal watercraft, as that term is used in the claims, refers to kayaks, canoes, SUPs, and surfboards. As is known, kayaks have a generally oval cockpit opening; canoes are fully open across the gunwales (i.e., from side-to-side); SUPs and surfboards are generally flat and their transverse dimensions are defined by their external perimetal edges.

Although these personal watercraft may weigh as little as 12 pounds when made of carbon, carbon/Kevlar composites, or other lightweight materials, their weight may commonly be in the 30-70 pound range or higher. While the weight alone of these personal watercraft may make then difficult or unwieldly to lift, especially to the height of a car roof-mounted rack, the way in which a user must grab or grasp the personal watercraft in such a lifting scenario causes the user's hands/wrists to be rotated. The resulting position/orientation of the lifter's hands/wrists and arms is not optimum for strength or positional control of a long, heavy personal watercraft.

It would be advantageous to be able to more easily, or at least more controllably, lift and maneuver such a personal watercraft.

### SUMMARY

An aspect of the invention is a personal watercraft lifting apparatus. In an exemplary embodiment, the personal watercraft lifting apparatus includes an elongate member having an adjustable, fixable length and having opposing distal ends and a gripping part; and a shaped end member fixedly or removable disposed on each respective distal end, each shaped end member having a shape adapted to engage a perimetal edge region or an external side region of the personal watercraft. In various non-limiting, exemplary embodiments the personal watercraft lifting apparatus may include some or all of the following features, components, steps, limitations, and/or characteristics, alone or in non-limiting variations appreciated by those skilled in the art:
wherein the gripping part comprises a holding component integrally or removeably attached to the elongate member in a lateral orientation thereto, said holding component including two opposing holding regions;
   wherein the gripping part has a curvilinear shape;
   wherein the gripping part has an opposing L-shape;
wherein the gripping part is an integral holding region of the elongate member;
   further comprising a leveraging member fixedly or removable disposed on the elongate member adjacent the integral holding region;
wherein the elongate member having an adjustable, fixable length comprises a hole/peg assembly;
wherein the elongate member having an adjustable, fixable length comprises a twist-to-tighten/loosen assembly;
wherein the elongate member having an adjustable, fixable length comprises a ratchet assembly;
wherein the shaped end member is generally convex;
wherein the shaped end member is generally concave.

An aspect of the invention is a method for lifting a personal watercraft. In an exemplary embodiment, the method includes providing a personal watercraft lifting apparatus comprising an elongate member having an adjustable, fixable length and having opposing distal ends and a gripping part, and a shaped end member fixedly or removable disposed on each respective distal end, each shaped end member having a shape adapted to engage a perimetal edge region or an external side region of the personal watercraft; adjusting the length of the elongate member such that each shaped end member either: a) engages opposing interior locations of the personal watercraft, or b) engages opposing external regions of the personal watercraft; and fixing the adjusted length to secure the elongate member per the (a) or the (b) engagement.

In its most general form, the embodied apparatus comprises one or a pair of length-adjustable, elongate bars/members with opposing, shaped end pieces that can be adjusted and reversibly fixed at a length such that the shaped ends engage the gunwales of a canoe near the center of longitudinal rotation, or the inner perimetal opening of a kayak's cockpit, or the outer opposing sides of a SUP or surfboard, in a direction transverse to the major longitudinal orientation of the personal watercraft. When fixed in place across a mid- or balancing or center-point-section of the personal watercraft, a person/user can straight-away (i.e., without twisted/rotated wrists) grasp the one or pair of bars with both hands and more easily and/or controllably lift and maneuver the personal watercraft. As appreciated by any personal watercraft user, there is no structure to grasp it in such a manner. In a particularly advantageous aspect, the bar or bars will include a component that can engage with the lifter's inner/under forearms while gripping the bar(s) to provide additional leverage and thus even greater control.

According to the embodied invention, the bar or bars can be collapsed and stowed when not in use, and easily be put into operational position when desired.

### BRIEF DESCRIPTION OF THE DRAWINGS

FIG. 1A schematically shows a top plan view of a single member personal watercraft lifting apparatus operationally disposed on a canoe; FIG. 1B schematically shows a top plan view of a pair of members personal watercraft lifting apparatus operationally disposed in a cockpit of a kayak, according to exemplary embodiments of the invention.

FIG. 2A schematically shows a side view of a single member personal watercraft lifting apparatus including a gripping component in the form of opposing L-shapes wherein the vertically-oriented L-sections provide a grasping surface for each of the user's hands; FIG. 2B schematically shows a side view of a single member personal watercraft lifting apparatus including a gripping component in the form of a curvilinear ‘handlebar,’ the distal ends of which provide a grasping surface for each of the user's hands, according to exemplary embodiments of the invention.

FIG. 3A schematically shows a side cross sectional view of a personal watercraft lifting apparatus illustrating a straight elongate member having concave profile shaped ends; FIG. 3B schematically shows a side cross sectional view of a personal watercraft lifting apparatus illustrating a straight elongate member having convex profile shaped ends; FIG. 3C schematically shows a side cross sectional view of a personal watercraft lifting apparatus illustrating a curved elongate member having concave profile shaped ends; FIG. 3D schematically shows a side cross sectional view of a personal watercraft lifting apparatus illustrating a straight elongate member having jaw-type shaped ends, according to exemplary embodiments of the invention.

FIG. 4A schematically shows a side cross sectional view of a personal watercraft lifting apparatus illustrating a clamping lever for fixing the length adjustment of the elongate member and also providing a cupped support for the underside of a user's forearm for additional leverage; FIG. 4B schematically shows a side cross sectional view of a personal watercraft lifting apparatus illustrating a clamping lever for fixing the length adjustment of the elongate member and also providing a flat support for the underside of a user's forearm for additional leverage, according to exemplary embodiments of the invention.

FIG. 5A schematically shows a hole/peg length adjustment assembly; FIG. 5B schematically shows a twist-to-tighten/loosen length adjustment assembly; FIG. 5C schematically shows a ratchet-type length adjustment assembly, according to exemplary embodiments of the invention.

### DETAILED DESCRIPTION OF NON-LIMITING, EXEMPLARY EMBODIMENTS

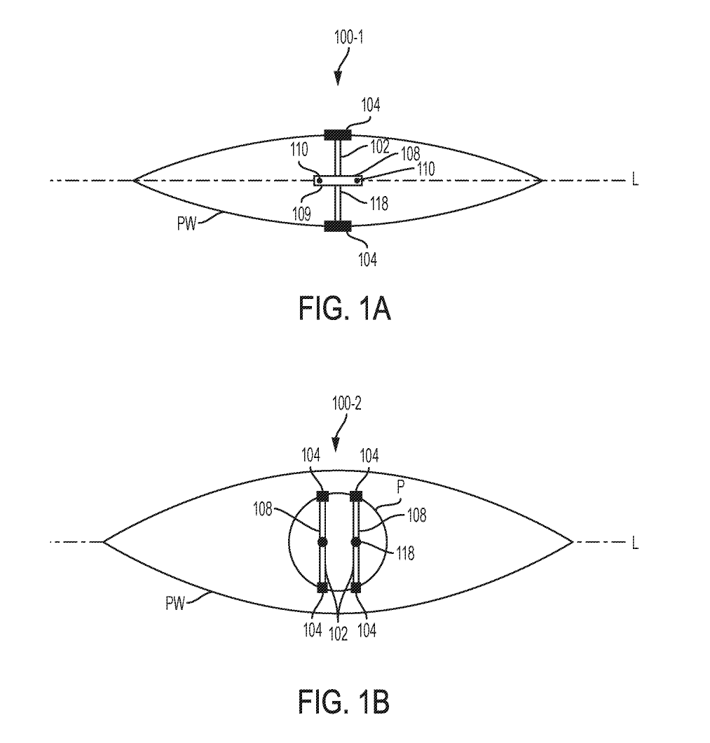

An aspect of the invention is a personal watercraft lifting apparatus. In an exemplary embodiment illustrated in FIG. 1A, a top-down view of a personal watercraft lifting apparatus 100-1 includes an elongate member 102 having an adjustable, fixable length and having opposing distal ends and a gripping part 108. A shaped end member 104 is fixedly or removable disposed on each respective distal end, each shaped end member having a shape adapted to engage an appropriate region of the personal watercraft. In FIG. 1A the personal watercraft, PW (not part of the invention per se), is a canoe, such that the appropriate region where the shaped end 104 are engageable with the PW are the gunwales (tops of the sides) in a generally centered location along the longitudinal axis, L, of the PW. In this embodiment, the gripping part 108 includes a holding component 109 that is integrally or removeably attached to the elongate member 102 in a lateral orientation (along L) thereto as illustrated, said holding component including two opposing holding regions 110.

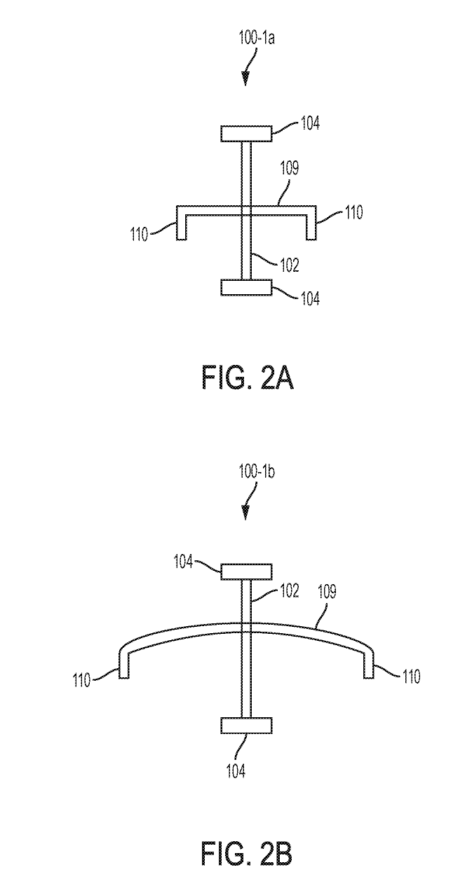

FIG. 2A is a schematic side view of an embodied personal watercraft lifting apparatus 100-1a, which shows the holding component 109 as a straight section and the two opposing holding regions 110 in the form of an opposing L-shape. Thus a user would attach the appropriately shaped end 104 to an appropriate region of the PW; once secured, the user could then grasp the two opposing holding regions 110 with both hands respectively, without having to turn or twist his/her wrists, enabling easier and more controlled lifting of the PW.

FIG. 2B is a schematic side view of another embodied personal watercraft lifting apparatus 100-1b, which shows the holding component 109 as a curved (in the plane of the paper) section and the two opposing holding regions 110 in the form of straight or slightly-curved sections of the bar. Similarly to lifting apparatus 100-1a, the user can grasp the two opposing holding regions 110 with both hands respectively, without having to turn or twist his/her wrists, enabling easier and more controlled lifting of the PW.

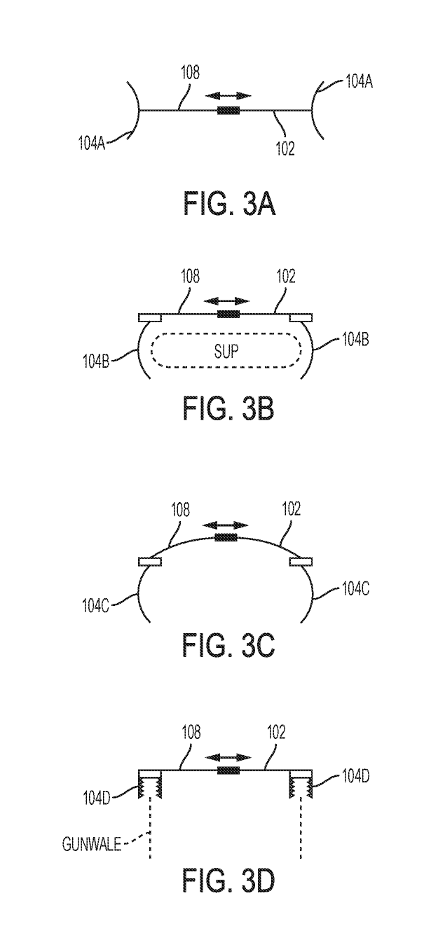

FIGS. 3A, 3B, 3C, 3D illustrate alternative shapes for the shaped end sections 104, each being appropriate depending on the type of PW to which they are being engaged. For example, for a canoe, the shaped end sections may advantageously be concave shaped as in FIG. 3A or of a jaw type as in FIG. 3D. The concave shaped ends would engage the inside surfaces of the gunwales of the canoe, while the jaw-type shaped end sections would come down on the tops of the gunwales. The concave shaped end section would also be appropriate for engaging opposing perimetal edges of the cockpit of a kayak. The end sections may be connected to the elongate member by a swivel or flexible assembly.

FIG. 3B illustrated convex-shaped end sections. These would be appropriate for engaging the opposing outer sides of a SUP or surf board, for example, as there are no other edges or regions of those types of PW to engage.

FIG. 3C is similar to FIG. 3B except that the elongate member 102 is curved in such a manner that a user has more distance between the top surface of the PW and the gripping part 108.

FIG. 1B illustrates an alternative embodiment 100-2 to that of 100-1 in that, instead of a single personal watercraft lifting apparatus having a holding component 109, the gripping part 108 is along a section of the adjustable elongate member 102, in which case two personal watercraft lifting apparatus are used to engage and lift the PW. In this embodiment, the gripping part 108 may be a textured or rubberized surface section, for example, of the elongate member. Utilization is similar to that of the single unit embodiment 100-1; two personal watercraft lifting apparatus are secured to the appropriate regions of the PW approximately shoulder-width apart. Again, the user can grasp each of the gripping parts 108 with each hand without having to turn or twist his/her wrists, enabling easier and more controlled lifting of the PW.

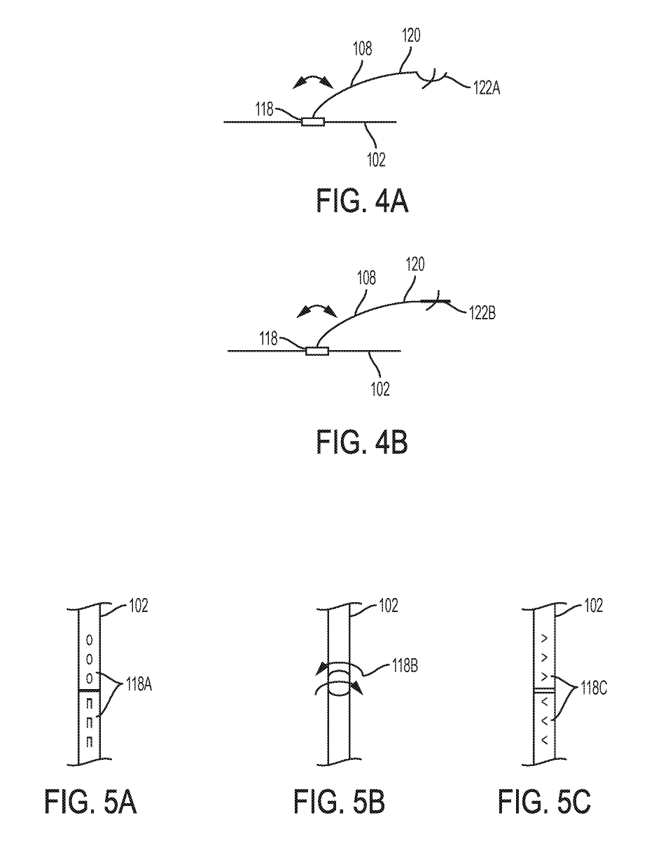

FIG. 4A schematically shows a side cross sectional view of a personal watercraft lifting apparatus illustrating an arm or clamping lever 120 connected to the elongate member and also providing a cupped support 122A for the underside of a user's forearm for additional leverage. Depending upon the type of mechanism for securing the length adjustment of the elongate member 102, are 120 may be used to constrict the elongate member to fix the length when pressure is applied to the arm 120.

FIG. 4B schematically shows a side cross sectional view of a personal watercraft lifting apparatus illustrating an arm or clamping lever 120 for fixing the length adjustment of the elongate member and also providing a flat support 122B for the underside of a user's forearm for additional leverage.

FIG. 5A schematically shows a spring-loaded hole/button length adjustment assembly 118A for reversibly fixing the length adjustment of the elongate member. FIG. 5B schematically shows a twist-to-tighten/loosen length adjustment assembly 118B. FIG. 5C schematically shows a spring-loaded ratchet-type length adjustment assembly 118C, according to exemplary embodiments of the invention.

The elongate bar members may be tubular, flat, or have any other suitable cross sectional geometry that provides sufficient strength, rigidity, and grasping convenience.

It will be appreciated that a relatively long, relatively heavy object, when lifted to be raised to head height or above, has considerable torque that is accentuated by the way a lifter must position his/her hands (i.e., twisted wrists) while lifting. The embodied invention tends to mitigate this accentuation by eliminating the need to twist one's wrists to accomplish the lifting motion.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As may be used herein and in the appended claims for purposes of the present disclosure, the term ‘about’ means the amount of the specified quantity plus/minus a fractional amount of or reasonable tolerance thereof that a person skilled in the art would recognize as typical and reasonable for that particular quantity or measurement. Likewise, the term ‘substantially’ means as close to or similar to the specified term being modified as a person skilled in the art would recognize as typical and reasonable as opposed to being intentionally different by design and implementation.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

I claim:

1. A personal watercraft lifting apparatus, comprising:
an elongate member having an adjustable, fixable length and having opposing distal ends and a gripping part; and
a shaped end member fixedly or removable disposed on each respective distal end, each shaped end member having a shape adapted to engage a perimetal edge region or an external side region of the personal watercraft.

2. The personal watercraft lifting apparatus of claim 1, wherein the gripping part comprises a holding component integrally or removeably attached to the elongate member in a lateral orientation thereto, said holding component including two opposing holding regions.

3. The personal watercraft lifting apparatus of claim 1, wherein the gripping part has a curvilinear shape.

4. The personal watercraft lifting apparatus of claim 1, wherein the gripping part has an opposing L-shape.

5. The personal watercraft lifting apparatus of claim 1, wherein the gripping part is an integral holding region of the elongate member.

6. The personal watercraft lifting apparatus of claim 1, further comprising a leveraging member fixedly or removable disposed on the elongate member adjacent the integral holding region.

7. The personal watercraft lifting apparatus of claim 1, wherein the adjustable, fixable length is provided by a hole/button assembly.

8. The personal watercraft lifting apparatus of claim 1, wherein the adjustable, fixable length is provided by a twist-to-tighten/loosen assembly.

9. The personal watercraft lifting apparatus of claim 1, wherein the adjustable, fixable length is provided by a ratchet assembly.

10. The personal watercraft lifting apparatus of claim 1, wherein the end component cross sectional profile is generally convex.

11. The personal watercraft lifting apparatus of claim 1, wherein the end component cross sectional profile is generally concave.

12. The personal watercraft lifting apparatus of claim 1, wherein the gripping component is integrally disposed on one of one of the first and second telescoping sections and the length adjustment component.

13. The personal watercraft lifting apparatus of claim 1, wherein the gripping component comprises a textured surface of one of the first and second telescoping sections or the length adjustment component.

14. A method for lifting a personal watercraft, comprising:
providing a personal watercraft lifting apparatus comprising an elongate member having an adjustable, fixable length and having opposing distal ends and a gripping part, and a shaped end member fixedly or removable disposed on each respective distal end, each shaped end member having a shape adapted to engage a perimetal edge region or an external side region of the personal watercraft;
adjusting the length of the elongate member such that each shaped end member either:
a) engages opposing interior locations of the personal watercraft, or
b) engages opposing external regions of the personal watercraft; and
fixing the adjusted length to secure the elongate member per the (a) or the (b) engagement.
